(19) United States
(12) Patent Application Publication
(10) Pub. No.: US 2017/0215251 A1
(43) Pub. Date: Jul. 27, 2017

(54) Modeling illumination device

(71) Applicant: Chung-Ping LAI, Zhubei City (TW)

(72) Inventor: Chung-Ping LAI, Zhubei City (TW)

(21) Appl. No.: 15/003,808

(22) Filed: Jan. 22, 2016

(51) Int. Cl. H05B 37/02; H05B 33/08

(52) U.S. Cl. CPC H05B 37/0218; H05B 33/0872; H05B 37/0272; H05B 33/0854

(57) ABSTRACT

A modeling illumination device contains: a surface light emitter, an ambient light sensor, and a controller. The surface light emitter includes a plurality of light emitting diodes of various colors in a matrix arrangement so as to emit lights of various colors in different modes. The ambient light sensor (ALS) is configured to sense a color temperature of ambient lights, to transform the color temperature into a color-temperature signal, and to transmit the color-temperature signal. The controller is electrically connected with the surface light emitter and the ambient light sensor, wherein the controller changes brightness and operation of the plurality of light emitting diodes based on the color-temperature signal produced by the ambient light sensor.

### FIELD OF THE INVENTION

The present invention relates to a modeling illumination device which emits lights of various colors in different modes, such as blue sky mode, white cloud mode, sunshine mode, or illuminating mode.

### BACKGROUND OF THE INVENTION

A conventional illumination device emits lights like natural lights, such as sunlight. It is to be noted that color temperature of the sunlight in noon is around 5500K, color temperature of the sunlight in the morning and the afternoon is about 2700K to 4000K.

However, the color temperature of the conventional illumination device is fixed and cannot be changed based on using requirements. For example, color temperature of incandescent bulb is around 2800K, color temperature of yellow fluorescent lamp is around 3500K, and color temperature of daylight fluorescent lamp is around 6500K.

The present invention has arisen to mitigate and/or obviate the afore-described disadvantages.

### SUMMARY OF THE INVENTION

The primary objective of the present invention is to provide a modeling illumination device which emits lights of various colors in different modes, such as blue sky mode, white cloud mode, sunshine mode, or illuminating mode.

To obtain above-mentioned objective, a modeling illumination device provided by the present invention contains: a surface light emitter, an ambient light sensor, and a controller.

The surface light emitter includes a plurality of light emitting diodes of various colors in a matrix arrangement so as to emit lights of various colors in different modes.

The ambient light sensor is configured to sense a color temperature of ambient lights, to transform the color temperature into a color-temperature signal, and to transmit the color-temperature signal.

The controller is electrically connected with the surface light emitter and the ambient light sensor, wherein the controller changes brightness and operation of the plurality of light emitting diodes based on the color-temperature signal produced by the ambient light sensor.

The surface light emitter further includes a support plate, a light emitting unit arranged on the support plate, and a light diffusion plate disposed above the light emitting unit; the light emitting unit has the plurality of light emitting diodes of the various colors in the matrix arrangement.

Colors of the plurality of light emitting diodes are bright white, warm white, and blue, respectively.

Colors of the plurality of light emitting diodes are bright white, red, green, and blue, respectively.

The ambient light sensor senses brightness of ambient lights, transforms the brightness into a brightness signal, and transmits the brightness signal.

The controller changes brightness and operation of the plurality of light emitting diodes based on the color-temperature signal and/or the brightness signal produced by the ambient light sensor.

The ambient light sensor has a first wireless communication unit, the controller has a second wireless communication unit which receives and transmits a brightness signal from the first wireless communication unit of the ambient light sensor, and the color-temperature is sent to the controller in a wireless transmission manner.

Each of the first wireless communication unit and the second wireless communication unit is bluetooth low energy module.

A color temperature sensor is electrically connected with the micro controlling unit of the controller and is configured to sense color temperature of lights from the surface light emitter, to convert the color temperature into a second color-temperature signal and to send the second color-temperature signal to the micro controlling unit.

A manual control panel is electrically connected with the controller, and the controller includes a modeling control program built therein so that user starts the modeling control program by using the manual control panel to change the brightness and the operation of the plurality of light emitting diodes.

The controller controls the surface light emitter to operate the plurality of light emitting diodes and to change the colors and the brightness of the plurality of light emitting diodes based on a set time, thus achieving wake-up mode.

### BRIEF DESCRIPTION OF THE DRAWINGS

FIG. 1 is a block diagram showing the function of a modeling illumination device according to a first embodiment of the present invention.

FIG. 2 is a block diagram showing the function of a modeling illumination device according to a second embodiment of the present invention.

FIG. 3 is a top plan view showing a plurality of light emitting diodes being formed on a surface light emitter in a matrix arrangement according to the first embodiment of the present invention.

FIG. 4 is a cross sectional view taken along the line IV-IV of FIG. 3.

FIG. 5A is a top plan view showing the operation of a plurality of light emitting diodes of a modeling illumination device according to a third embodiment of the present invention.

FIG. 5B is a top plan view showing the operation of a plurality of light emitting diodes of a modeling illumination device according to a fourth embodiment of the present invention.

FIG. 6 is another block diagram showing the function of the modeling illumination device according to the second embodiment of the present invention.

### DETAILED DESCRIPTION OF THE PREFERRED EMBODIMENTS

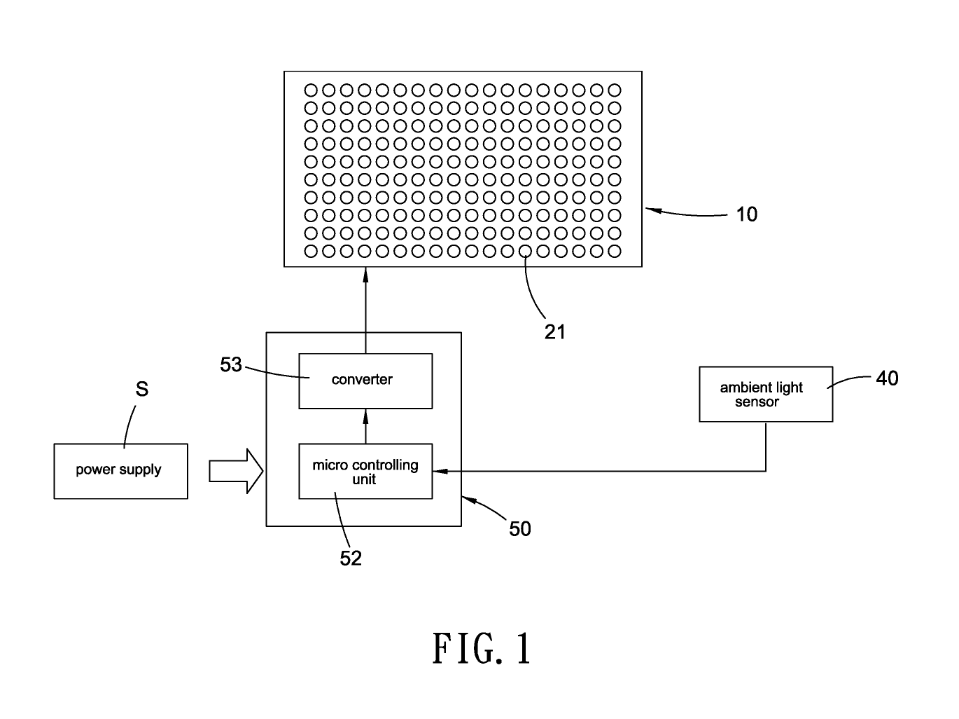

With reference to FIG. 1, a modeling illumination device according to a first embodiment of the present invention comprises:

a surface light emitter 10 including a plurality of light emitting diodes 21 of various colors in a matrix arrangement so as to emit lights of various colors in different modes;

an ambient light sensor (ALS) 40 configured to sense a color temperature of ambient lights, to transform the color temperature into a color-temperature signal, and to transmit the color-temperature signal; and

a controller 50 including a modeling control program built therein and electrically connected with the surface light emitter 10 and the ambient light sensor 40, the modeling control program of the controller 50 changing brightness and operation (such as emitting lights or stopping emitting lights) of the plurality of light emitting diodes 21 based on the color-temperature signal produced by the ambient light sensor 40.

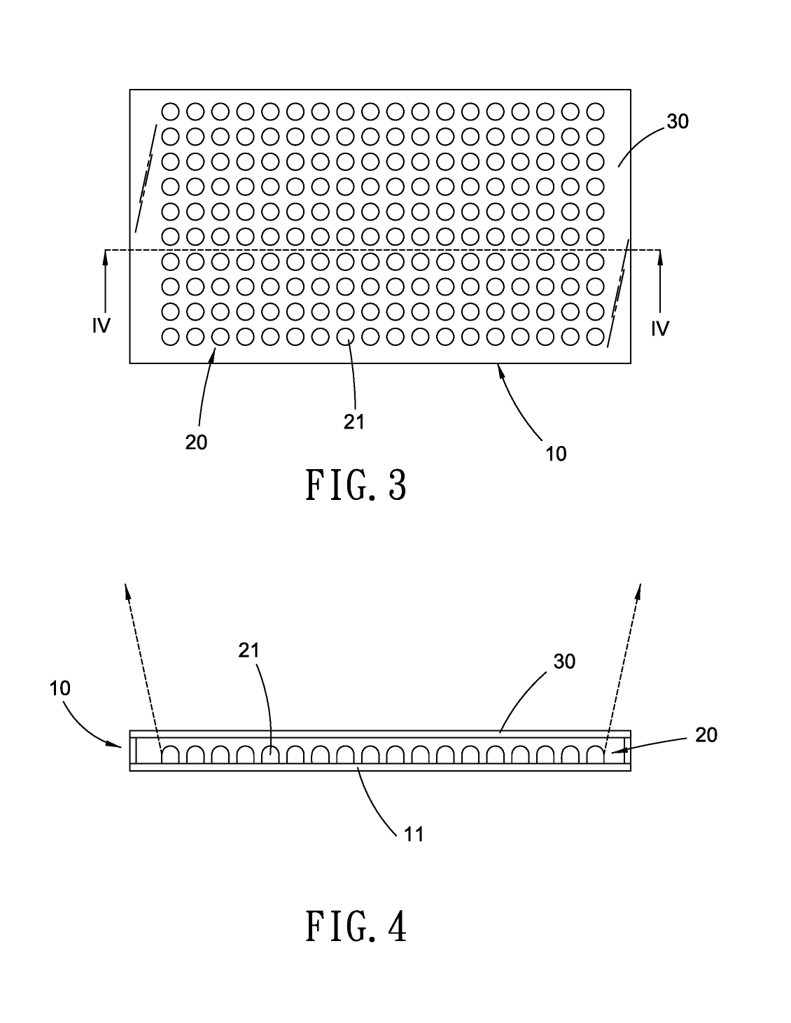

Referring to FIGS. 3 and 4, the surface light emitter 10 further includes a support plate 11, a light emitting unit 20 arranged on the support plate 11, and a light diffusion plate 30 disposed above the light emitting unit 20 and configured to increase light emitting angle and the brightness.

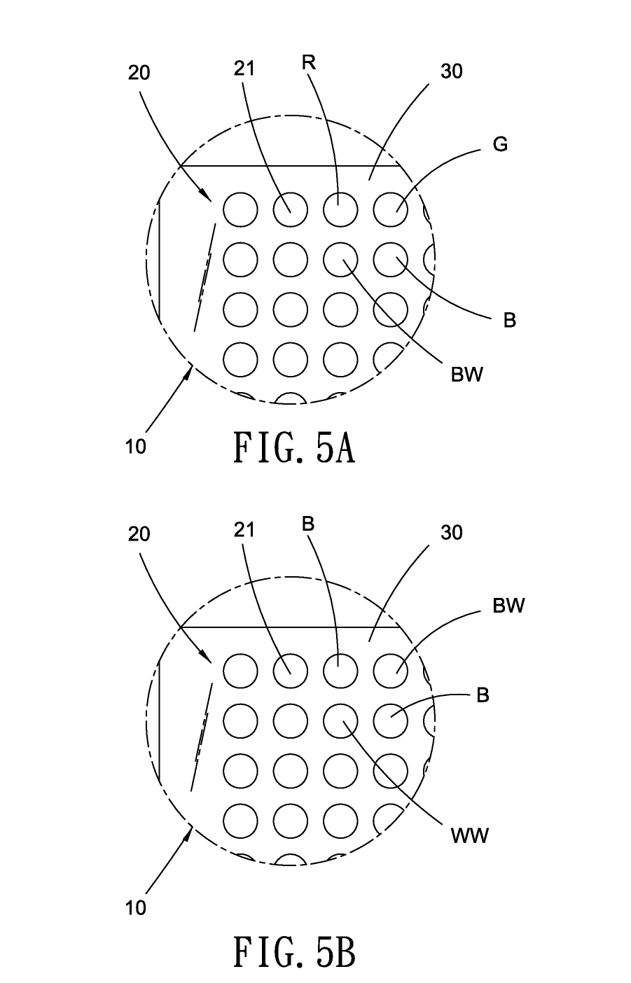

As shown in FIG. 5A, in a third embodiment, the light emitting unit 20 has the plurality of light emitting diodes 21, and colors of the plurality of light emitting diodes 21 are bright white (BW), warm white (WW), and blue (B), respectively.

In a fourth embodiment, as illustrated in FIG. 5B, colors of the plurality of light emitting diodes 21 are bright white (BW), red (R), green (G), and blue (B), respectively. Thereby, the light emitting unit 20 emits lights of various colors in different modes.

The ambient light sensor 40 senses the color temperature of the ambient lights and transforms the color temperature into a first color-temperature signal, then the first color-temperature signal is sent to the controller 50 by the ambient light sensor 40, wherein the ambient light sensor 40 is electrically connected with the controller 50 in a wired transmission manner.

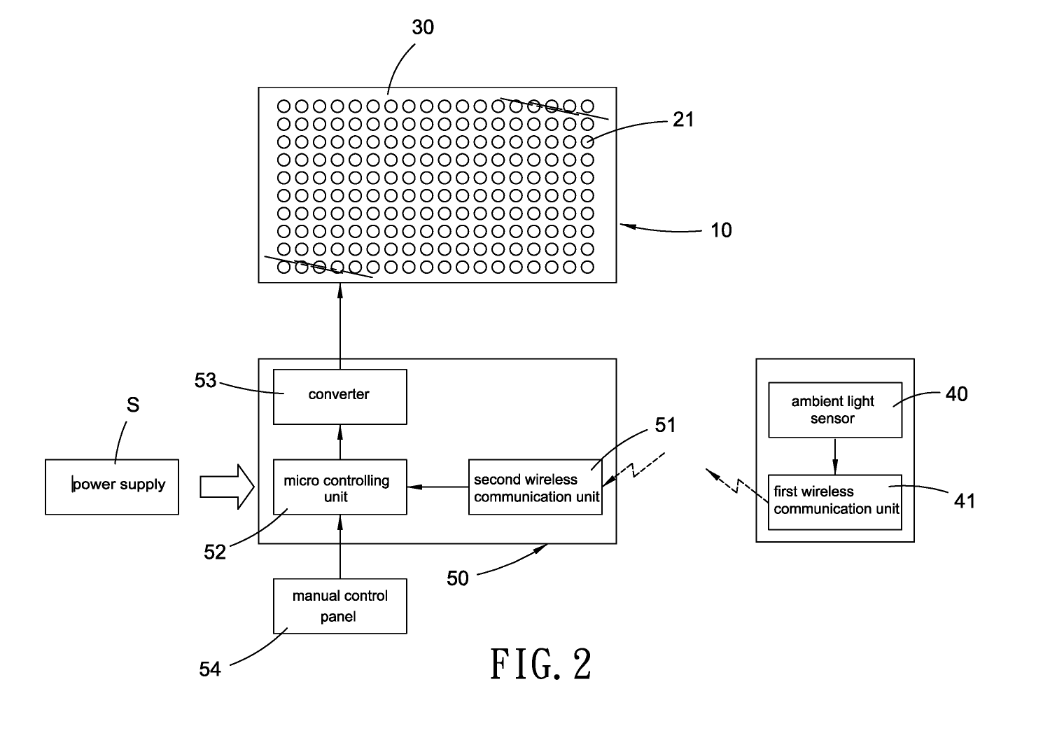

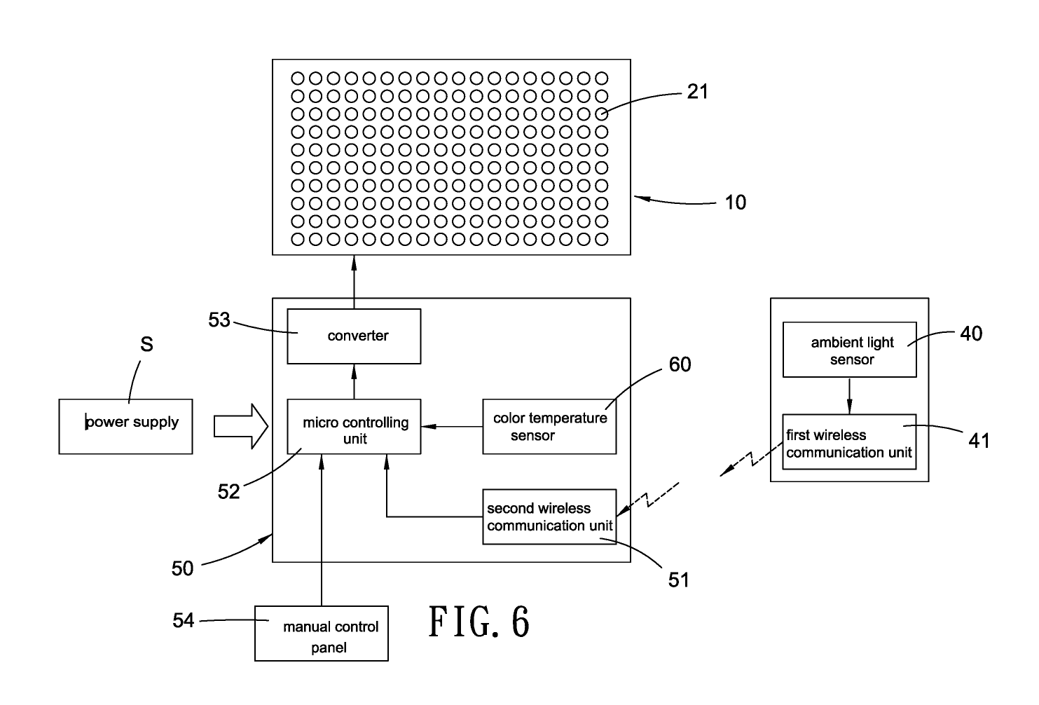

With reference to FIGS. 2 and 6, in a second embodiment, an ambient light sensor 40 is electrically connected with a controller 50 in a wireless transmission manner, wherein the ambient light sensor 40 has a first wireless communication unit 41, and the controller 50 has a second wireless communication unit 51 receives and transmits a brightness signal from the first wireless communication unit 41 of the ambient light sensor 40, wherein each of the first wireless communication unit 41 and the second wireless communication unit 51 is bluetooth communication unit, such as bluetooth low energy module (BLE module). The ambient light sensor 40 senses brightness of ambient lights, transforms the brightness into the brightness signal, and transmits the brightness signal.

In the first embodiment and the second embodiment, the controller 50 is a digital controller and includes a micro controlling unit (MCU) 52 and a converter 53. The micro controlling unit 52 has a modeling control program built therein, an input end of the converter 53 is electrically coupled with a power supply S (such as a constant-voltage power supply), an output end of the converter 53 is electrically connected with the surface light emitter 10, wherein the converter 53 is a DC-DC converter, and the micro controlling unit 52 is electrically connected with the ambient light sensor 40 so that the modeling control program of the micro controlling unit 52 changes brightness and operation (such as emitting lights or stopping emitting lights) based on the color-temperature signal and/or the brightness signal produced by the ambient light sensor 40. Preferably, the micro controlling unit 52 produces pulse width modulation (PWM) signal for controlling output mode (such as constant current or constant voltage) of the converter 53, and the converter 53 drives the plurality of light emitting diodes 21 of the light emitting unit 20 to operate (such as emitting lights or stopping emitting lights) or to change brightness of the plurality of light emitting diodes 21, thus emitting lights of various colors in different modes.

The surface light emitter 10 emits lights of various colors in different modes, such as static lighting mode or dynamic lighting mode. When the surface light emitter 10 emits the lights in the static lighting mode, the brightness and the color temperature of the plurality of light emitting diodes 21 do not change. When the surface light emitter 10 emits the lights in the dynamic lighting mode, the brightness and the color temperature of the plurality of light emitting diodes 21 change.

For example, in the static lighting mode, the brightness and the operation (such as emitting lights or stopping emitting lights) of the plurality of light emitting diodes 21 are automatically or manually adjusted by way of the controller 50. As shown in FIG. 1, the brightness and the operation (such as emitting lights or stopping emitting lights) of the plurality of light emitting diodes 21 are automatically adjusted by using the controller 50 based on the color-temperature signal produced by the ambient light sensor 40. As illustrated in FIG. 2, the controller 50 includes the modeling control program built therein and includes a manual control panel 54 electrically connected with the controller 50 so that user starts the modeling control program by using the manual control panel 54 to change the brightness and the operation (such as emitting lights or stopping emitting lights) of the plurality of light emitting diodes 21, thus emitting lights of various colors in different modes, such as blue sky mode, white cloud mode, sunshine mode, or illuminating mode.

For example, in the sunshine mode, the plurality of light emitting diodes 21 emit lights from a left side of the surface light emitter 10 to a right side of the surface light emitter 10. Alternatively, the plurality of light emitting diodes 21 emit lights from the right side of the surface light emitter 10 to the left side of the surface light emitter 10. In addition, the plurality of light emitting diodes 21 changes their brightness and color temperature from the left side of the surface light emitter 10 to the right side of the surface light emitter 10, thus producing sunrise-like effect and sunset-like effect. Alternatively, the plurality of light emitting diodes 21 changes their brightness and color temperature from the right side of the surface light emitter 10 to the left side of the surface light emitter 10, thus producing sunrise-like effect and sunset-like effect. In the illuminating mode, half of the plurality of light emitting diodes 21 emit the lights, and the other of the plurality of light emitting diodes 21 do not emit the lights.

Referring to FIG. 6, a difference of the modeling illumination device of the second embodiment from that of the first embodiment comprises: a color temperature sensor 60 electrically connected with the micro controlling unit 52 of the controller 50 and configured to sense color temperature of the lights from the surface light emitter 10, to convert the color temperature into a second color-temperature signal and to send the second color-temperature signal to the micro controlling unit 52, the micro controlling unit 52 produces pulse width modulation (PWM) signal according to the second color-temperature signal produced by the color temperature sensor 60, and an output mode of the converter 53 is adjusted via the pulse width modulation (PWM) signal to automatically compensate colors of the lights (i.e., the color temperature) from the surface light emitter 10.

In another embodiment, the controller 50 controls the surface light emitter 10 to operate (such as emitting lights or stopping emitting lights) the plurality of light emitting diodes 21 and to change colors and brightness of the plurality of light emitting diodes 21 based on a set time, thus achieving wake-up mode.

The modeling illumination device of the present invention is installed on ceiling or wall in a building to emit blue and white lights like clear sky, white lights like sunshine, or green lights like forest.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A modeling illumination device comprising:
a surface light emitter including a plurality of light emitting diodes of various colors in a matrix arrangement so as to emit lights of various colors in different modes;
an ambient light sensor (ALS) configured to sense a color temperature of ambient lights, to transform the color temperature into a color-temperature signal, and to transmit the color-temperature signal; and
a controller electrically connected with the surface light emitter and the ambient light sensor, wherein the controller changes brightness and operation of the plurality of light emitting diodes based on the color-temperature signal produced by the ambient light sensor;
wherein a color temperature sensor is electrically connected with the micro controlling unit of the controller and is configured to sense color temperature of lights from the surface light emitter, to convert the color temperature into a second color-temperature signal and to send the second color-temperature signal to the micro controlling unit.

2. The modeling illumination device as claimed in claim 1, wherein the surface light emitter further includes a support plate, a light emitting unit arranged on the support plate, and a light diffusion plate disposed above the light emitting unit; the light emitting unit has the plurality of light emitting diodes of the various colors in the matrix arrangement.

3. The modeling illumination device as claimed in claim 1, wherein colors of the plurality of light emitting diodes are bright white, warm white, and blue, respectively.

4. The modeling illumination device as claimed in claim 1, wherein colors of the plurality of light emitting diodes are bright white, red, green, and blue, respectively.

5. The modeling illumination device as claimed in claim 1, wherein the ambient light sensor senses brightness of ambient lights, transforms the brightness into a brightness signal, and transmits the brightness signal.

6. The modeling illumination device as claimed in claim 5, wherein the controller changes brightness and operation of the plurality of light emitting diodes based on the color-temperature signal and/or the brightness signal produced by the ambient light sensor.

7. The modeling illumination device as claimed in claim 1, wherein the ambient light sensor has a first wireless communication unit, the controller has a second wireless communication unit which receives and transmits a brightness signal from the first wireless communication unit of the ambient light sensor, and the color-temperature is sent to the controller in a wireless transmission manner.

8. The modeling illumination device as claimed in claim 7, wherein each of the first wireless communication unit and the second wireless communication unit is bluetooth low energy module.

9. (canceled)

10. The modeling illumination device as claimed in claim 1, wherein a manual control panel is electrically connected with the controller, and the controller includes a modeling control program built therein so that user starts the modeling control program by using the manual control panel to change the brightness and the operation of the plurality of light emitting diodes.

11. The modeling illumination device as claimed in claim 1, wherein the controller controls the surface light emitter to operate the plurality of light emitting diodes and to change the colors and the brightness of the plurality of light emitting diodes based on a set time, thus achieving wake-up mode.
